(19) United States
(12) Patent Application Publication
(10) Pub. No.: US 2024/0242010 A1
(43) Pub. Date: Jul. 18, 2024

(54) METHOD AND TOOL FOR PLANNING AND DIMENSIONING SUBSEA PIPELINE-BASED TRANSPORT SYSTEMS FOR MULTIPHASE FLOWS

(71) Applicant: LEDAFLOW TECHNOLOGIES DA, Asker (NO)

(72) Inventors: Jørn Kjølaas, Tiller (NO); Ivar Eskerud Smith, Trondheim (NO); Jonathan Nees, Oslo (NO)

(73) Assignee: LEDAFLOW TECHNOLOGIES DA, Asker (NO)

(21) Appl. No.: 18/563,224

(22) PCT Filed: Jun. 9, 2022
(86) PCT No.: PCT/EP2022/065688

§ 371 Date: Nov. 21, 2023

(30) Foreign Application Priority Data
Jun. 10, 2021 (NO) 20210752

(51) Int. Cl. G06F 30/28; G06F 30/23; G06F 30/27; G06F 111/10; G06F 113/14

(52) U.S. Cl. CPC G06F 30/28; G06F 30/23; G06F 30/27; G06F 2111/10; G06F 2113/14

(57) ABSTRACT

This invention relates to a computer-implemented method for predicting fluid behaviour in pipeline-based transport systems for transport of multiphase flows involving slug flows which forces one-dimensional CFD models to predict a Taylor bubble velocity being equal to a predetermined Taylor bubble velocity known to be realistic. The enforcement of the 1D CFD model to arrive at the predetermined Taylor bubble velocity is obtained by introducing a force term in the momentum equation for the gas phase at and near the slug-tail top and which is proportional to the difference between the Taylor bubble velocity predicted by the CFD model and the predetermined Taylor bubble velocity. The invention further relates to an autonomous system applying the computer-implemented method.

### FIELD OF INVENTION

This invention relates to a computer-implemented method for predicting fluid behaviour in pipeline-based transport systems for transport of multiphase flows which may involve hydrodynamic plug flows. The invention relates further to a 1D CFD model which may provide more realistic predictions of the Taylor bubble velocity.

### BACKGROUND

The petroleum industry is under persistent pressure to minimize the environmental impact of new developments while remaining profitable even in oil price downturns. A key element for achieving these goals has been to tie new wells to existing infrastructure instead of building new installations for each development.

This has proven to be successful strategy, but new hydrocarbon reserves are discovered at increasing distances from existing processing units, and the unprocessed fluids may in some cases need to be transported hundred kilometres or more.

Multiphase fluid transport over such distances is challenging for several reasons, and one of the main obstacles is the risk for long slugs. Specifically, it is known that liquid slugs tend to grow when travelling large distances, and this must be accounted for in the design and operation of the production systems. Being able to correctly predict the characteristics of slug flow is of great importance, both in the design phase of hydrocarbon production facilities, and during operation.

In the design phase, the slug sizes and frequency of slugs are important parameters for designing the size of the receiving facilities, like the slug catcher/separator. Here, under-design can lead to severe operational problems that limit the lifetime of the production system, as well as frequent abnormal shutdowns with substantial production losses. In addition, the forces exerted on pipe bends and free-span piping is sensitive to the slugging characteristics. Specifically, slugs cause load variations and subsequent vibrations that reduce the lifetime of pipe fittings and other vulnerable components. When a field is in operation, being able to predict the slug characteristics is important for investigating the effect of possible mitigating actions, like topside choking or gas lift to reduce the severity of slugging.

The average liquid holdup and pressure drop are also important: Underpredicting the pressure drop might lead to an undersized pipeline diameter, and thus reduced capacity during the production phase. An overprediction of the pressure drop on the other hand might cause an oversizing of the pipeline diameter that could create flow instabilities and degrade the operability of the system. These matters are vital for the economy and feasibility of all hydrocarbon production systems, and accurate simulation models are needed to predict the consequences of different designs and approaches.

### PRIOR ART

The modelling of gas-liquid pipe flow, and especially the ability to predict slug flow, by computational fluid dynamic (CFD) models has been investigated extensively in both the oil and gas industry and in the nuclear reactor industry.

The computer codes of CFD-software usually consist of three main elements: (i) a pre-processor, (ii) a solver, and (iii) a post-processor. The pre-processor element concerns the definition/input of the fluid flow problem to be simulated. The post-processor element concerns the output of the simulation/simulation results etc. The solver element concerns the numerical solution of the natural laws governing transport phenomena, convection, diffusion and if present, any source terms.

The governing equations of the fluid flow are mathematical statements expressing the conservation laws of physics to ensure conservation of mass, momentum, and energy of the fluid. Furthermore, these equations are non-linear and coupled, meaning that for instance the momentum equation depends on the solution of the mass equation and vice versa. The fluid is treated as a continuum where its behaviour is described in terms of macroscopic properties such as velocity, pressure, density, and temperature.

When simulating an oil-field pipeline, regular two- or three-dimensional CFD codes are typically unfeasible due to the physical dimensions/length of the pipes, and it may take years to finish a simulation. The modelling of long pipelines by computational fluid dynamic numerical models is therefore always performed using one-dimensional (1D) averaged conservation equations to achieve acceptable simulation times. In such 1D-models, the equations are averaged over the width and height of the pipe, yielding a one-dimensional model which is computationally much faster and can simulate the pipeline within reasonable time frames. Such models are, in the literature often referred to as two-fluid or three-fluid models. However, the averaging procedure discards terms in the transport equations making the 1D model being more approximative than the original governing equations. This makes the 1D model dependent on empirical correlations tuned against experimental data and/or additional model components to obtain good results.

The most-commonly used approach for modelling slug flow is to apply a relatively coarse grid, together with a sub-grid model which treats slug flow in an averaged manner, assuming local steady-state-fully developed flow. This type of modelling is often referred to as the Unit-Cell Model (UCM) approach, based on the concept first presented by Dukler and Hubbard [1]. This model can predict both the liquid holdup and pressure drop but is only able to give the average slug fraction in the pipe with no information about either slug length or slug frequency.

An alternative approach for modelling slug flow, commonly referred to as “slug capturing”, was first proposed by Issa [2]. In slug capturing, the 1D multiphase flow equations are solved on a relatively fine grid, eliminating the need for the sub-grid model used in the UCM approach. With this approach, waves grow naturally from instabilities and develop into slugs, without the need for special initiation models.

One of the most important aspects of slug flow modelling is to accurately predict the velocity of the large bubbles separating the slugs (Taylor bubbles). The Taylor bubble velocity determines how much liquid the slugs shed at the slug tail, and also largely governs the average liquid holdup in slug flow. Thus, a too-large velocity leads to the slugs decreasing in length (possibly dying), while a too-low velocity makes the slugs grow. In other words, the Taylor bubble velocity is a parameter which has a large effect on the slug lengths.

Sanderse et al. [3] showed that it is not possible to obtain the correct Taylor bubble drift velocity with the regular 1D model equations without introducing a correction. The reason for this is that the velocity of Taylor bubbles is a product of mechanisms that are inherently three-dimensional, and some of the associated effects are inevit-ably lost when the equations are averaged to 1D.

However, there are several analytically formulated models in the literature known to provide realistic predictions of the Taylor bubble velocities. Such models are typically all based on the same principle. Examples of this model and various improvements include Bendiksen [4], Dumitrescu [5], Gokcal [6], Jeyachandra et al. [7], and Viana et al. [8].

### Objective of the Invention

The main objective of the invention is to provide a computer implemented method for predicting fluid behaviour of a multiphase flow in a pipeline-based transport system by a 1D CFD-model.

A further objective of the invention is to provide a computer implemented method for predicting fluid behaviour of a multiphase flow in a pipeline-based transport system involving hydrodynamic slug flows by a 1D CFD-model providing more accurate Taylor bubble velocities.

Another objective of the invention is to provide a computer implemented method for designing transport systems for multiphase fluid flows.

A further objective of the invention is a computer implemented simulation tool for designing/optimising and/or trouble-shooting a pipeline-based transport system for multiphase fluid flows.

### DESCRIPTION OF THE INVENTION

The invention is based on the realisation that the known shortcomings of one-dimensional CFD models in predicting Taylor bubble velocities may be overcome by forcing the CFD model to predict a Taylor bubble velocity being equal to a predetermined Taylor bubble velocity calculated from e.g. an analytically formulated Taylor bubble velocity model, like the ones previously mentioned, or determined in another way. The enforcement of the CFD model to arrive at the predetermined Taylor bubble velocity is according to the invention obtained by introducing a force term in the momentum equation for the gas phase at and near the slug-tail top and which is proportional to the difference between the Taylor bubble velocity predicted by the CFD model and the predetermined Taylor bubble velocity.

In general, the gas momentum equation may be simplified and written as follows:

$$\frac{\partial ( {M}_{g} {U}_{g} )}{\partial L} + {FRIC}_{g} + {GRAV}_{g} + {CONV}_{g} + … = 0 \qquad ( 1 )$$

where M_{g} is mass of the gas phase, U_{g} is the velocity of the gas phase, FRIC_{g} is the friction terms of the gas phase, GRAV_{g} is the gravity terms of the gas phase, and CONV_{g} is the convection terms of the gas phase. The friction and convection terms are dependent on both mass and velocity.

The gas momentum equation can for instance be discretised to be linearly dependent on the new gas velocity as shown in eqn. (2):

$$\frac{{M}_{g}^{n + 1} {U}_{g}^{n + 1} - {M}_{g}^{n} {U}_{g}^{n}}{Δ t} + {FRIC}_{g} ( {U}_{g}^{n + 1} ) + G R A {V}_{g} + {CONV}_{g} ( {U}_{g}^{n + 1} ) + … = 0 \qquad ( 2 )$$

where U_{g}ⁿ⁺¹ is the new gas velocity at the next time step n+1 and U_{g}ⁿ is the gas velocity at the current time step n. And similarly, M_{g}ⁿ⁺¹ is the new mass of the gas phase at the next time step n+1 and M_{g}ⁿ is the mass of the gas phase at the current time step n.

The discretised momentum equation may be rearranged and simplified by collecting all terms multiplied with the n+1'th gas velocity on the left-hand side, and the remaining terms on the right-hand side:

$${A}_{g} \cdot {U}_{g}^{n + 1} = {B}_{g} \qquad ( 3 )$$

where term A_{g} contains the new mass of gas,

$$\frac{{M}_{g}^{n + 1}}{Δ t} ,$$

and coefficients from both friction and convection. Term B_{g} contains terms from the explicit part of the time derivative,

$$( \frac{{M}_{g}^{n} {U}_{g}^{n}}{Δ t} ) ,$$

and the gravity term.

The same procedure can be used when a force term defined as F(U_{g}−U_{b}) is introduced in the gas momentum equation, where F is a force factor, U_{g} is the predicted (by the CFD model) Taylor bubble velocity and U_{b} is a predetermined Taylor bubble velocity. The gas momentum equation is then:

$$\frac{{M}_{g}^{n + 1} {U}_{g}^{n + 1} - {M}_{g}^{n} {U}_{g}^{n}}{Δ t} + {FRIC}_{g} ( {U}_{g}^{n + 1} ) + {GRAV}_{g} + {CONV}_{g} ( {U}_{g}^{n + 1} ) + F ( {U}_{g}^{n + 1} - {U}_{b} ) + … = 0 \qquad ( 4 )$$

This may be rearranged and simplified to read:

$$( {A}_{g} + F ) \cdot {U}_{g}^{n + 1} = {B}_{g} + F {U}_{b} \qquad ( 5 )$$

When the factor F becomes large, i.e., F>>A_{g} and F>B_{g}/U_{b}, eqn. (5) may be approximated as:

$$F \cdot {U}_{g}^{n + 1} = F {U}_{b} \qquad ( 6 )$$

Thus, a large value of the force factor F makes the predicted Taylor bubble velocity approach the predetermined Taylor bubble velocity. It is evident to the person skilled in the art that the variables M_{g}ⁿ⁺¹, Δx, U_{g}ⁿ⁺¹, F and A_{g} and B_{g} are evaluated locally, i.e. for each i'th finite control volume of the computational domain. The index i has however been omitted for the sake of ease of nomenclature.

In order to preserve momentum in the CFD simulation, a similarly sized and opposite directed force term is added to the momentum equation for the neighbouring liquid phase, i.e. the liquid phase being in contact with gas in the same control volume:

$$\frac{\partial ( {M}_{l} {U}_{l} )}{\partial t} + {FRIC}_{l} + {GRAV}_{l} + {CONV}_{l} - F ( {U}_{g} - {U}_{b} ) + … = 0 \qquad ( 7 )$$

where Mₗ is mass of the gas phase, U_{g} is velocity of the gas phase, FRICₗ is the friction terms of the liquid phase, GRAVₗ is the gravity terms of the liquid phase, and CONVₗ is the convection terms of the liquid phase. Applying the same discretisation scheme and simplification and rearrangement as for the gas momentum equation, the momentum equation for the liquid, eqn. (7), may be given as:

$${A}_{l} {U}_{l}^{n + 1} - {FU}_{g}^{n + 1} = {B}_{l} - {FU}_{b} \qquad ( 8 )$$

where term Aₗ contains the new mass of liquid, and coefficients from both friction and convection. Term Bₗ contains terms from the explicit part of the time derivative, and the gravity term.

Thus, in a first aspect, the invention relates to a computer implemented method for predicting fluid behaviour of a multiphase flow in a pipeline-based transport system where the flow contains at least one gas phase and one liquid phase, wherein the method comprises:
applying a one-dimensional (1D) computational fluid dynamic (CFD) model describing the geometry of a section of interest of the pipeline-based transport system and the multiphase flow flowing therein, and
solving the 1D CFD model to simulate the fluid behaviour of the multiphase flow in the section of interest of the pipeline-based transport system, wherein
the 1D CFD model applies a finite volume method to solve the model, wherein the geometry of the section of interest of the pipeline-based transport system is defined as a computational domain extending along an axis represented by the cartesian coordinate x and being divided into a set of N, where N is a positive integer, non-overlapping finite control volumes separated by an internal face between adjacent finite control volumes, characterised in that the 1D CFD model is adapted to:
search for and identifying slug-tail tops in the computational domain, where a slug-tail top is defined to be a finite control volume having a gas fraction of less than 0.02 and an upstream neighbouring finite control volume with a gas fraction of more than 0.02, and
for each identified slug-tail top, define a slug tail domain consisting of the slug-tail top and each finite control volume lying within a distance Lₜₐᵢₗ extending in an upstream direction of the slug tail top, where the distance

$${L}_{tail} = Δ x ( 4 + \frac{1}{Δ {x}^{*}} ) ,$$

$$where Δ {x}^{*} = 1 if \frac{Δ x}{D} \leq 15 or Δ {x}^{*} = {e}^{\frac{Δ x}{15 D} - 1} if \frac{Δ x}{D} > 15 ,$$

and Δx is a cell length of the finite control volume,
and further characterised in that
the 1D CFD model, for each identified slug-tail domain, is further adapted to apply a slug-tail correction comprising:
a gas velocity correction for each finite control volume of the slug-tail domain by adding to the gas momentum equation, a force term, F(U_{g}ⁿ⁺¹−U_{b})·W, where F is a force factor, U_{g}ⁿ⁺¹ is a gas velocity at a next time step n+1 applied by the CFD-model, U_{b} is a predetermined Taylor bubble velocity, W is a weight function having a value of 1 for the finite control volume at the slug tail top and a value between 0 and 1 for the finite control volumes lying within the distance Lₜₐᵢₗ, and where F≥10·max(|A_{g}|, |B_{g}/U_{b}|), where A_{g} and B_{g} are obtained by rearranging the adapted gas momentum equation on the form:

$$( {A}_{g} + F \cdot W ) \cdot {U}_{g}^{n + 1} = {B}_{g} + F \cdot W \cdot {U}_{b}$$

and
apply a liquid velocity correction for each finite control volume of the slug-tail domain for a neighbouring liquid fluid phase in contact with the gas phase of the multiphase flow by subtracting from the momentum equation for the neighbouring liquid phase the force term, F(U_{g}ⁿ⁺¹−U_{b})·W.

The present invention is not limited to any choice of discretisation scheme or numerical solution algorithm except that the 1D CFD-model shall apply a finite volume method approach and the force term is implicit in velocity. The gas momentum equation can be discretised in many ways, including fully-implicit schemes in both mass and velocity, purely explicit schemes, or a combination of both.

As used herein, the term “pipeline-based transport system” encompasses all components of the transport system necessary to transport the fluid including pipeline segments, splits, joins, valves, pumps, sources, sinks, etc. An example of a pipeline-based transport system for produced liquids in oil and gas extraction is shown in FIG. 1 which illustrates schematically an example embodiment of such transportation system. This example embodiment comprises a plurality of tie-backs/pipelines (2) connecting a production well (1) to a nearby satellite hub (3) which collects the produced fluid in a region and passes the produced fluid in a satellite pipeline (4) to a common hub (5). The example embodiment comprises four satellite hubs (3) connected to the common (5) by a satellite pipeline (4) each. The common hub (5) passes the produced fluid to a processing facility located either offshore on the sea surface via a riser (not shown in this embodiment) or to an onshore production facility via fluid transportation pipeline (6). The transport system usually involves one or more fluid pumps (7) to provide the necessary flow pressure to move the fluids through the transport system. The above example embodiment should not be interpreted narrowly. The pipeline-based transport system may have any conceivable configuration from a single pipeline for fluid transport, to interconnected networks pipelines for fluid transport in e.g. chemical process industry plants, for connecting offshore production facilities to onshore produced fluid receiving facilities etc.

As used herein, the term “predetermined Taylor bubble velocity” refers to a reference value at which the adapted 1D CFD model according to the first aspect of the invention is made by the adaption to predict. The predetermined Taylor bubble velocity may be obtained in any suitable way known to the person skilled in the art such as e.g. determining Taylor bubble velocities empirically, predicting the predetermined Taylor bubble velocity by direct Navier-Stokes simulations, or predicting the predetermined Taylor bubble velocity by an analytically formulated model from the literature such as e.g. the models of Bendiksen [4], Dumitrescu [5], Gokcal [6], Jeyachandra et al. [7], or Viana et al. [8].

It is observed that the adapted 1D CFD model according to the first aspect of the invention may in some cases become unstable if the force factor becomes too large, or if its value changes to rapidly from cell to cell. Thus, in an example embodiment, the 1D CFD model according to the first aspect of the invention, to obtain a smooth and decreasing force in the slug tail domain the weight function W may be determined for each finite control volume of the slug-tail domain by the relation:

$$W = MAX ( 0 , 0.5 ( 1 - tanh ( \frac{6 L}{5 \frac{Δ x}{D}} - 3 - \frac{1}{Δ {x}^{*}} ) ) ) \cdot Ψ ( Fr ) \qquad ( 9 )$$

where the function ψ(Fr) is:

$$Ψ ( Fr ) = 0.5 ( 1 + tanh ( 10 ( Fr - 0.5 ) ) ) \qquad ( 10 )$$

the Froude number, Fr, is:

$$Fr = \frac{\vert {U}_{mix} \vert}{\sqrt{gD cos ( θ ) ( \frac{{ρ}_{l} - {ρ}_{g}}{{ρ}_{l}} )}} \qquad ( 11 )$$

and where L is the distance from the i'th finite control volume of the slug-tail domain to the slug-tail top, g is the gravity, Uₘᵢₓ is the total volumetric flow rate divided by the pipe's cross-sectional area, θ is the pipe angle measured relative to the horizontal plane, ρ_{g} is the gas density, and ρₗ, is the volumetric mean of the densities of one or more liquids being in the finite control volume. The weight factor W of eqn. (9) is designed to be equal to 1 at the slug tail top and go towards zero at the upstream end of the slug-tail domain (away from the slug).

As used herein, the term “slug-tail domain” is a sub-domain of the computational domain encompassing all finite control volumes lying from a slug-tail top and a distance Lₜₐᵢₗ in upstream direction, i.e. the distance Lₜₐᵢₗ extends in a direction opposite the flow direction. Thus, the term “downstream direction” as used herein means a direction in the flow direction, while the term “upstream direction” as used herein means a direction in opposite direction of the flow direction.

FIG. 2 is a drawing illustrating an example of a slug flow involving a liquid and a gas phase inside a section of a pipeline. The solid line marked with reference number 1 is a large-scale interface separating the continuous gas phase from the continuous liquid phase of the multiphase flow. The position of the large-scale interface is scaled as 1−α, where a is the gas fraction. Each dot 2 on line 1 marks the center position in the cartesian coordinate x of the finite control volumes applied by a 1D CFD model of the pipeline segment. The stapled arrow 3 shows the direction of the multiphase flow. As seen on the figure, a continuous gas phase/Taylor bubble 4 pushes on a plug 5 of liquid (slug) which fills the entire cross section of the pipe.

The finite control volume marked with reference number 6 lies at the slug-tail top, i.e. the rear (upstream) end of the liquid plug. The distance Lₜₐᵢₗ extends in an upstream direction (i.e. in a direction opposite the flow direction) which in this in example embodiment encompasses 4 neighbouring finite control volumes marked with reference number 7. Thus, the slug-tail domain in this example embodiment includes the finite control volume 6 at the slug-tail top and its 4 nearest neighbouring finite control volumes 7 in the upstream direction.

It is well known from the literature that the analytically formulated Taylor bubble velocity models are less suited for short slugs. For short slugs, disturbances from the slug front will propagate through the slug and affect the velocity profile at the Taylor bubble nose behind it, making the Taylor bubble nose accelerate. This has been verified experimentally in several studies, and many correlations for the increase in Taylor bubble velocity as function of the slug length have been proposed. This wake effect will make the shorter slugs (typically <10 D in length) shed more liquid at the slug tail than longer slugs, and this process leads to short slugs dying and turning into large waves. The prevailing waves, which tend to move slower than slugs, are then consumed by trailing slugs which subsequently increase in length. The present inventors have found that the wake effect may have a profound effect on the predicted slug lengths. Without a wake effect correction, the prevailing slug length distribution in the predicted flow may contain too many short slugs, and too few large slugs, which in some cases may lead to grid convergence problems. Specifically, as the computational grid is refined, shorter and shorter slugs are resolved, and without the wake effect to eliminate small slugs, the result would be a slug frequency largely dependent on the grid size.

Thus, in an example embodiment, the invention according to the first aspect of the invention may further be adapted to include a wake effect correction where the predetermined Taylor bubble velocity is adjusted as a function of the slug length, L_{S}, such as e.g. the correction developed by Cook & Behnia [9] which reads:

$${U}_{b} = {U}_{b , ∞} ( 1 + 0.56 {e}^{- 0.46 \frac{{L}_{S}}{D}} ) \qquad ( 13 )$$

where U_{b,∞} is the velocity of a Taylor bubble that is pushing a long slug not affected by the wake effect, L_{S} is the length of the slug in front of the Taylor bubble and D is the inner diameter of the pipe.

In an example embodiment, the method according to the first aspect of the invention the 1D CFD model may apply a slug-capturing approach where the 1D multiphase flow equations are solved on a grid with Δx≤10·D, where Δx is a cell length of a finite control volume of the section of interest and D is an inner diameter of a pipeline of the section of interest.

In a second aspect, the invention relates to a method for optimising the design of a pipeline-based fluid transportation system for transporting a multiphase fluid flow, wherein the method comprises:
preparing at least two different designs of the fluid transportation system,
applying the computer implemented method according to the first aspect of the invention to predict the fluid behaviour in each of the at least two different designs, and
applying the predicted fluid behaviour to determine the optimised design of the fluid transportation system.

The optimisation of the design of the transportation system may take into consideration one or more factors such as pipeline diameter, pipeline trajectory in the terrain, number of pumps for pressure support, their location and pressure enhancing effect, number of choking valves, their location and flow volume reducing effect, etc. with the aim to save capital investment and operational costs by identifying the optimum physical dimensions and/or trajectory in the terrain of the transport systems pipes without compromising on fluid behaviour stability and throughput. Furthermore, the optimisation of the design of the pipeline-based fluid transportation system may in an example embodiment apply the simulated slug sizes and frequency of slugs to optimize the size of the receiving facilities such as slug catcher, and/or slug separator, etc. The optimisation of the design of the pipeline-based fluid transportation system may also, in a further example embodiment apply the simulated slug sizes and frequency of slugs to assess forces exerted on pipe bends and free-span piping in the pipeline-based fluid transportation system.

In a third aspect, the invention relates to a method for trouble-shooting flow problems during operation of a pipeline-based fluid transportation system for transporting a multiphase fluid flow, wherein the method comprises:
applying the computer implemented method according to first aspect of the invention loaded with a computational domain representative for the transport system having flow problems and with flow characteristic input data of the flow in the transportation system to predict the effect on the fluid behaviour in the transport system from possible mitigation actions, and
applying the predicted fluid behaviours to determine which mitigation action which is to be physically implemented on the transport system having flow problems.

The mitigation actions may be regulating the flow volumes in the transport system, topside choking, gas lift, and others.

In a fourth aspect, the invention relates to a computer program, comprising processing instructions which causes a computer to perform the method according to any of the first to the third aspects of the invention when the instructions are executed by a processing device in the computer.

In a fifth aspect, the invention relates to a computer, comprising a processing device and a computer memory, the computer memory is storing a computer program as set forth in the fourth aspect.

In a sixth aspect, the invention relates to an autonomous flow management system (100) comprising:
a flow simulation unit (30),
a sensor configuration comprising at least a first sensor (51) located at an upstream end (11) and a second sensor (51) located at an downstream end (12) of the pipeline-based transport system (10) and measuring one or more characteristic flow parameter(s) of the multiphase fluid flowing through the pipeline-based transport system (10),
an actuator configuration comprising at least one actuator (61) adapted to regulate the flow of fluid through the pipeline-based transport system (10), and
a control unit (20) adapted to:
   receive signals (53, 54) from the sensor configuration measuring one or more characteristic flow parameter(s) and transferring the signals to one or more boundary conditions (21) passed on to the flow simulation unit (30), and
   receive simulation results (32) from the flow simulation unit (30) and transferring the simulation results to set point values (22) passed on to the actuator(s) (61) of the actuator configuration,
      wherein
the flow simulation unit (30) comprises a computer loaded with a software, which when executed performs a computer-implemented method simulating the fluid behaviour of the multiphase flow flowing in the pipeline-based transport system (10) with the boundary condition(s) (21) from the control unit (20), characterised in that
the software of the computer of the flow simulation unit (30) is the computer program according to the fourth aspect of the invention.

The configuration of an example embodiment of the flow management system according to the invention is schematically illustrated in the diagram shown in FIG. 5. The pipeline-based transport system being managed by the flow management system 100 is shown schematically on the figure as a box 10 having an upstream end 11 receiving a fluid to be transported through the transport system to a downstream end 12 where the fluid is delivered to a fluid receiving facility. The flow management system comprises further control unit 20, a flow simulation unit 30, a sensor configuration comprising at least a first sensor 51 located at the upstream end 11 and a second sensor 52 located at the downstream end 12 of the pipeline-based transport system 10, and an actuator configuration comprising at least one actuator 61 adapted to regulate the through flow of one or more fluid phases of the multiphase flow.

In another example embodiment of the flow management system according to the invention, the flow management system further comprises a second actuator 62 located at the downstream end 12 and/or a third actuator (not shown in the figure) located anywhere in-between the upstream 11 and downstream 12 end of the pipeline-based transport system 10. In this embodiment, the set point-value for the second actuator 62 is transferred from the control unit as signal 23 and the set point-value for the third actuator is transferred from the control unit as signal 24. In one embodiment, the actuator 61, 62 of the actuator configuration is either a control valve, a drum separator, a compressor, a gas injector, or a pump.

In one embodiment, the control unit 20 may be a Distributed Control System, a Programmable Logic Controller, an Edge Gateway, a SCADA system or a Historian System or Timeseries Database being implemented to covering automation layers 0, 1, and 2 according the standard: ANSI/ISA-95.00.01-2010 (IEC 62264-1 Mod) Enterprise-Control System Integration—Part 1: Models and Terminology.

The control unit 20 receives sensor signals 53, 54 from the sensor configuration, which typically is electric signals, and transforms them into one or more measured flow parameter(s) such as e.g. flow velocity of one or more fluid phases, pressure, temperature, density of one or more fluid phases, volume or mass fraction of one or more fluid phases, etc. These measured one or more flow parameter(s) are passed on to the flow simulation unit (30) and applied as boundary condition(s) in the simulation of the multiphase flow.

The computer-implemented method for predicting the fluid behaviour may in some embodiments need information of the gas and liquid phase ratios and the temperature of the multiphase flow entering the transport-system at its upstream end to predict the fluid behaviour. In some appliances, the flow rates and thus gas and liquid phase ratios of the flow entering the pipeline-based transport system is constant or practically constant. In such cases the information of the gas and liquid phase ratios may be entered as an input variable for the computer-implemented method. Thus, in one embodiment, the first sensor 51 of the sensor configuration of the flow management system comprises at least a temperature sensor located at the upstream end 11 of the pipeline-based transport system 10. In other appliances, the gas and liquid phase ratios may vary. Thus, in one embodiment, the first sensor 51 of the sensor configuration of the flow management system comprises at least a flow sensor and a temperature sensor, both located at the upstream end 11 of the pipeline-based transport system 10.

In one embodiment, the first sensor 51 of the sensor configuration of the flow management system comprises a temperature sensor located at the upstream end 11 of the pipeline-based transport system 10, and:

either:
the first sensor 51 further comprises a pressure sensor and the second sensor 52 comprises a pressure sensor,
the first sensor 51 further comprises a pressure sensor and the second sensor 52 comprises a flow sensor,
the first sensor 51 further comprises a flow sensor and the second sensor 52 comprises a pressure sensor,
   or
the first sensor 51 further comprises a flow sensor and the second sensor 52 comprises a flow sensor.

The simulation results from the flow simulation unit are applied to regulate the flow in the pipeline-based transport system 10 by adjusting the actuator(s) 61 of the actuator configuration to set-point values determined by the control unit 20 taking the flow simulations results into account. The set point values may be determined by using one or several of the following algorithms that should be well known to those proficient in the art: PID control loop, Pre-trained machine learning algorithm, and/or Global or local optimum search algorithm.

### LIST OF FIGURES

FIG. 1 illustrates schematically an example embodiment of a pipeline system for transporting processed fluids in oil and gas extraction.

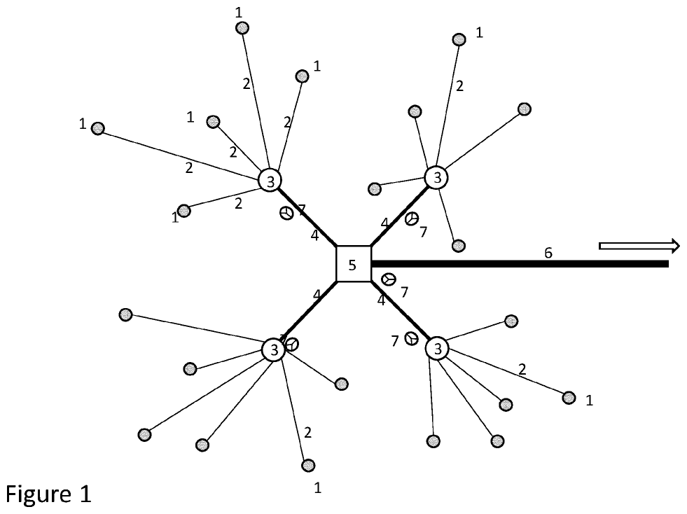

FIG. 2 is a drawing of a slug flow in a section of a pipeline illustrating an example of the slug-tail domain and distance Lₜₐᵢₗ as applied by the present invention.

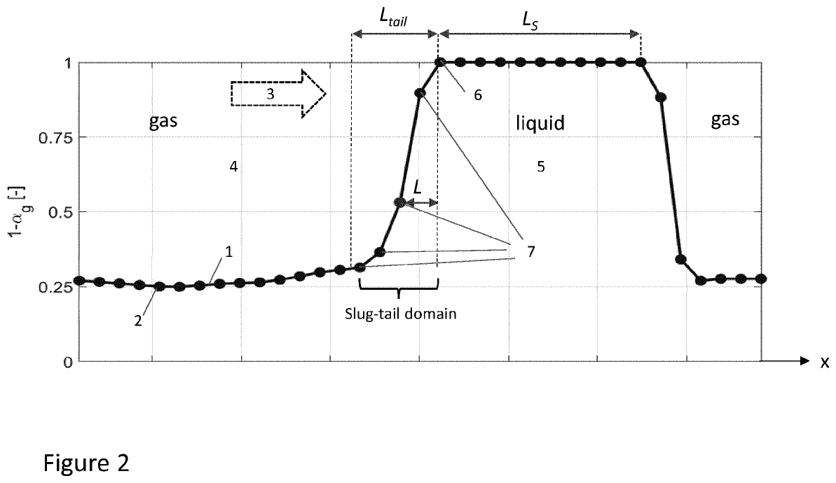

FIG. 3 is a diagram showing a comparison of predicted fluid behaviour of a slug in a horizontal pipeline by a 1D CFD model with and without the adaption of the prediction of the Taylor bubble velocity according to the invention.

FIG. 4 is a diagram illustrating another comparison of predicted fluid behaviour of a slug in a horizontal pipeline by a 1D CFD model. The figure shows the simulation results with and without the adaption of the prediction of the Taylor bubble velocity according to the invention, for different mixture velocities, compared to the predetermined (desired) Taylor bubble velocity.

FIG. 5 is a drawing schematically illustrating an example embodiment of a flow management system according to the invention.

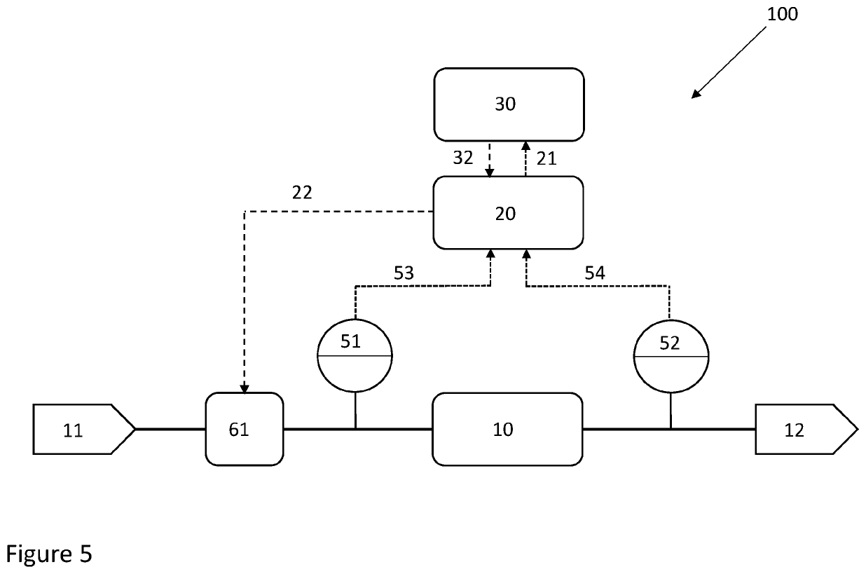

FIG. 6 is a drawing schematically illustrating another example embodiment of a flow management system according to the invention.

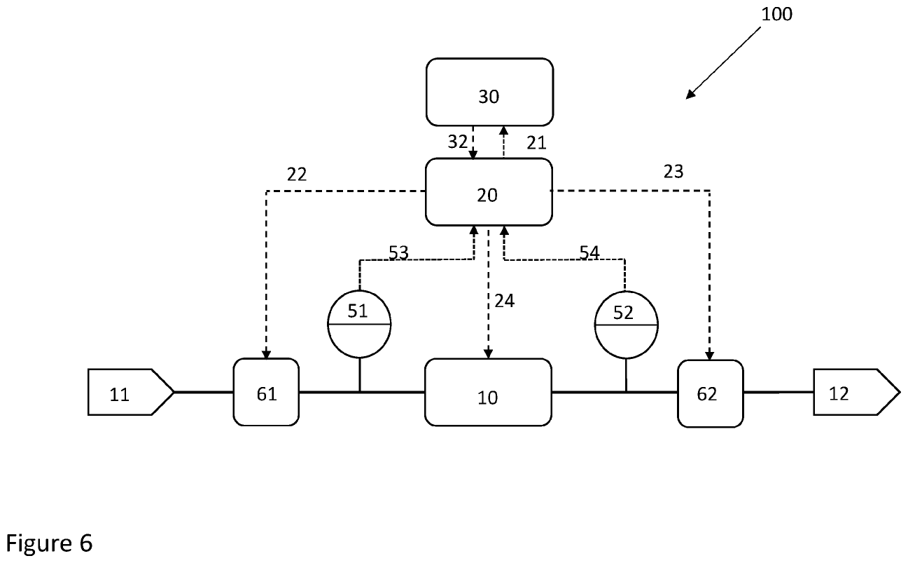

### VERIFICATION OF THE INVENTION

The invention will be described in further details by way of verification tests and an example of applying an analytically formulated model.

### Example 1

The following example demonstrates the effect of the slug bubble velocity force. A commercially available 1D CFD model, LedaFlow, was applied to simulate a multiphase flow in a 600 m long horizontal pipe with inner diameter 0.189 m with and without the adaption according to the first aspect of the invention. The fluid pressure in the flow was assumed to be 100 bar, and the gas and liquid density was set to 100 kg/m³ and 845 kg/m³, respectively. Both the gas and liquid were modelled as incompressible. The gas and liquid viscosities were set to 2·10⁻⁵ and 1·10⁻³ Pa*s, respectively.

The simulation was initialized with only gas. At t=0, liquid starts to flow into the pipe and fills the entire cross-section of the pipe to inject a slug into the pipe. At t=38.3 s, the input instantly switched from injecting liquid, to injecting pure gas. The injected mass flow rates into the pipe were such that the mixture velocity is always constant, at 3 m/s. As gas is flowing into the pipe, we have a situation with a slug moving into the pipe with a Taylor-bubble behind it. At these conditions, a predetermined Taylor bubble velocity as calculated by an analytically formulated model from the literature (LedaFlow's own model, based on the model by Bendiksen [4]), and is 3.6 m/s.

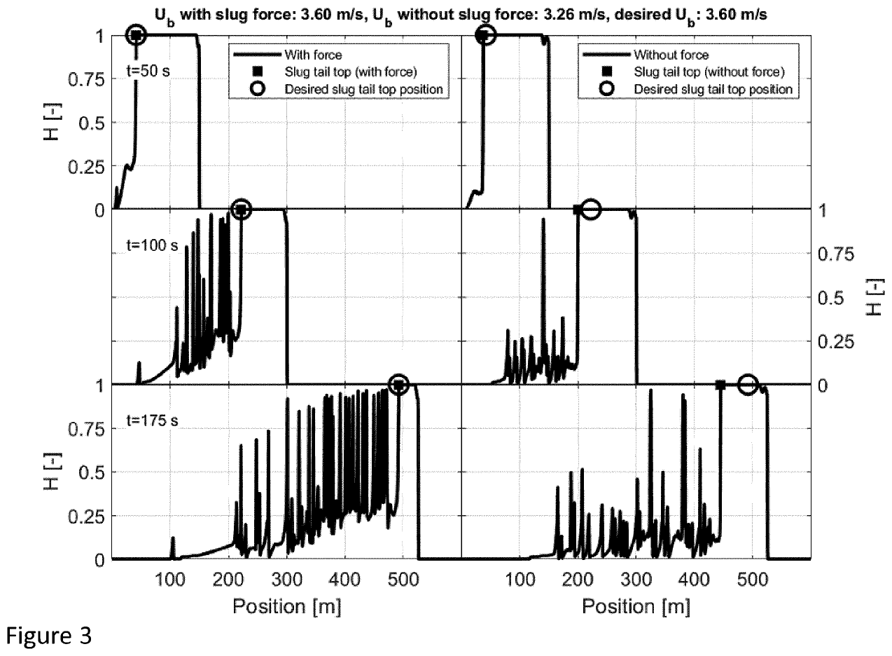

A comparison of the simulation results of the simulation at time t=50, 1=100 and t=175 s are shown in FIG. 3, for simulations both with the force enabled (left column) and without the force (right column). As the simulation progresses, the slug becomes smaller since there is not any liquid for the slug to absorb at the front, while the slug at the same time shed liquid at the tail.

The simulations were post-processed to detect the location of the slug tail top (top of the Taylor-bubble nose) for each time step, which is plotted with a black square. The position where the slug tail top should ideally be located (based on the desired velocity of 3.6 m/s) is also marked, with a black circle. One can clearly see that the location of the slug tail top in the simulation with the force enabled matches the desired position, while the Taylor bubble in the simulation with the force disabled clearly moves too slow. Using the first and last detected position of the slug tail top, the average Taylor bubble velocity was found to be 3.6 m/s when applying the adaption according to the invention and 3.26 m/s without the adaption according to the invention. I.e., with the adaption according to the invention the desired velocity is obtained exactly, while in the simulation without the adaption the simulation gives a too low velocity (about 9.5% too low). This is a substantial difference and will have a large impact on whether a slug survives or dies. One can also see that since the slug in the simulation with the force sheds more liquid, more liquid is left behind, which significantly affects the wave growth behind the slug.

### Example 2

In this example more simulations are performed as described in example 1, but for different mixture velocities. The only difference from example 1 is the mixture velocity, and the time in the simulation before switching from gas to liquid, which is calculated as 9.45+100/Uₘᵢₓ. The results were post-processed similarly to in example 1, detecting the slug tail top at every time step, and calculating the resulting velocity.

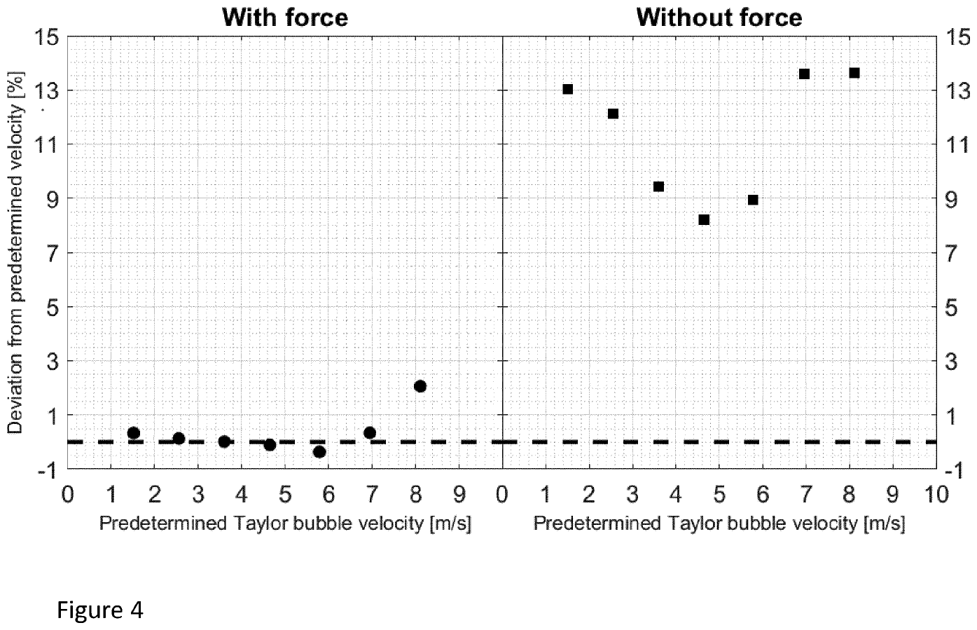

In FIG. 4 the deviations between the obtained and desired Taylor bubble velocities from simulations with and without the force are shown, in the left and right plot respectively. One can see that in the simulations with the force enabled, the deviation is typically within 0.5%, though at the largest mixture velocity the deviation is around 2%. This is much smaller than the deviations obtained without the force, where the error is ranging from about 9-13% (too low velocity).

Example of determination of the predetermined Taylor bubble velocity by an analytically formulated model

In this example it is applied the analytically formulated model of Bendiksen [4] to calculate a predetermined Taylor bubble velocity, U_{b}, which can be summarized as:

$${U}_{b} = {C}_{0} {U}_{mix} + {U}_{0} \qquad ( 14 )$$

$$where :$$

$$\begin{matrix}{C}_{0} & {U}_{0} & \\ 1.05 + 0.15 {sin ( θ )}^{2} & 0.351 sin ( θ ) \sqrt{gD} + 0.5 \; 42 cos ( θ ) \sqrt{gD} & {Fr}_{mix} < 3.5 \\ 1.2 & 0.351 sin ( θ ) \sqrt{gD} & {Fr}_{mix} \geq 3.5\end{matrix}$$

Here U_{b} is the Taylor-bubble velocity, Uₘᵢₓ is the mixture velocity, U₀ is the drift velocity, and θ the pipe inclination. Frₘᵢₓ is the mixture Froude number, defined as:

$$\frac{{U}_{mix}}{\sqrt{gD ( \frac{{ρ}_{l} - {ρ}_{g}}{{ρ}_{l}} )}} \qquad ( 15 )$$

ρ is the density, g the gravitational acceleration and D the pipe diameter. To simplify the calculation and to achieve continuity in U_{b} between the two Froude number equations, we choose the maximum value of the two.

To find the Taylor-bubble velocity for a cell i in the computational model, we use the mixture velocity, density and pipe properties from cell i in equation (14). Let us assume the values in cell i at a certain time-step are: ρₗ=1000, ρ_{g}=1, D=0.1, Uₘᵢₓ=3, θ=0, and g=9.81. The two Froude number equations then give the following values of which the largest is applied by the CFD-model:

$$\begin{matrix}{U}_{b} & = 1.05 \times 3 + 0.5368 = 3.6868 & {Fr}_{mix} < 3.5 \\ {U}_{b} & = 1.2 \times 3 = 3.6 & {Fr}_{mix} \geq 3.5\end{matrix}$$

### REFERENCES

1. Dukler, A. E. and M. G. Hubbard, “A Model for Gas-Liquid Slug Flow in Horizontal and Near Horizontal Tubes”, Industrial & Engineering Chemistry Fundamentals, 1975. 14(4): p. 337-347.
2. Issa, R. I. and M. H. W. Kempf, “Simulation of slug flow in horizontal and nearly horizontal pipes with the two-fluid model”, International Journal of Multiphase Flow, 2003. 29(1): p. 69-95.
3. Sanderse, B., M. Haspels, and R. A. W. M. Henkes, “Simulation of Elongated Bubbles in a Channel Using the Two-Fluid Model”, Journal of Dispersion Science and Technology, 2015. 36(10): p. 1407-1418.
4. Bendiksen, K. H. (1984). “An experimental investigation of the motion of long bubbles in inclined tubes.” International Journal of Multiphase Flow 10(4): 467-483.
5. Dumitrescu, D. (1943). “Strömung an Einer Luftblase im Senkrechten rohr.” Zeitschrift für Angewandte Mathematik und Mechanik 23(3): 139-149.
6. Gokcal, B. (2008). An Experimental and Theoretical Investigation of Slug Flow for High Oil Viscosity in Horizontal Pipes. Tulsa, University of Tulsa, Oklahoma. PhD: 146.
7. Jeyachandra, B. C., et al. (2012). “Drift-Velocity Closure Relationships for Slug Two-Phase High-Viscosity Oil Flow in Pipes.” SPE Journal 17(2): 593-601.
8. Viana, F., et al. (2003). “Universal correlation for the rise velocity of long gas bubbles in round pipes.” Journal of Fluid Mechanics 494: 379-398.
9. Cook M, Behnia M (2000) Slug length prediction in near horizontal gas liquid intermittent flow. Chem Eng Sci 55:2009-2018.

1. A computer implemented method for predicting fluid behaviour of a multiphase flow in a pipeline-based transport system where the flow contains at least one gas phase and one liquid phase, wherein the method comprises:
applying a one-dimensional (1D) computational fluid dynamic (CFD) model describing the geometry of a section of interest of the pipeline-based transport system and the multiphase flow flowing therein, and
solving the 1D CFD model to simulate the fluid behaviour of the multiphase flow in the section of interest of the pipeline-based transport system,
wherein
the 1D CFD model applies a finite volume method to solve the model, wherein the geometry of the section of interest of the pipeline-based transport system is defined as a computational domain extending along an axis represented by the cartesian coordinate x and being divided into a set of N, where N is a positive integer, non-overlapping finite control volumes separated by an internal face between adjacent finite control volumes, characterised in that the 1D CFD model is adapted to:
search for and identifying slug-tail tops in the computational domain, where a slug-tail top is defined to be a finite control volume having a gas fraction of less than 0.02 and an upstream neighbouring finite control volume with a gas fraction of more than 0.02, and
for each identified slug-tail top, define a slug tail domain consisting of the slug-tail top and each finite control volume lying within a distance Lₜₐᵢₗ extending in an upstream direction of the slug tail top, where the distance
$${L}_{tail} = Δx ( 4 + \frac{1}{Δ {x}^{*}} ) ,$$
$$where Δ {x}^{*} = 1 if \frac{Δ x}{D} \leq 15 or Δ {x}^{*} = {e}^{\frac{Δ x}{15 D} - 1} if \frac{Δ x}{D} > 15 ,$$
D is an inner diameter of the section of interest of the pipeline-based transport system, and Δx is a cell length of the finite control volume,
and further characterised in that
the 1D CFD model, for each identified slug-tail domain, is further adapted to apply a slug-tail correction comprising:
a gas velocity correction for each finite control volume of the slug-tail domain by adding to the gas momentum equation, a force term, F(U_{g}ⁿ⁺¹−U_{b})·W, where F is a force factor, U_{g}ⁿ⁺¹ is a gas velocity at a next time step n+1 applied by the CFD-model, U_{b} is a predetermined Taylor bubble velocity, W is a weight function having a value of 1 for the finite control volume at the slug tail top and a value between 0 and 1 for the finite control volumes lying within the distance Lₜₐᵢₗ, and where F≥10·max(|A_{g}|, |B_{g}/U_{b}|), where A_{g} and B_{g} are obtained by rearranging the adapted discretised gas momentum equation such that all terms multiplied with U_{g}ⁿ⁺¹ are placed on the left-hand side and the remaining terms are placed on the right-hand side, to give the adapted discretised gas momentum equation on the form:
$$( {A}_{g} + F \cdot W ) \cdot {U}_{g}^{n + 1} = {B}_{g} + F \cdot W \cdot {U}_{b}$$
and
apply a liquid velocity correction for each finite control volume of the slug-tail domain for a neighbouring liquid fluid phase in contact with the gas phase of the multiphase flow by subtracting from the momentum equation for the neighbouring liquid phase the force term, F(U_{g}ⁿ⁺¹−U_{b})·W.

2. The computer implemented method according to claim 1, wherein the weight function W is determined by the relation:
$$W = MAX ( 0 , 0.5 ( 1 - tanh ( \frac{6 L}{5 \frac{Δ x}{D}} - 3 - \frac{1}{Δ {x}^{*}} ) ) ) \cdot Ψ ( Fr )$$
$$where Ψ ( Fr ) = 0.5 ( 1 + tanh ( 10 ( Fr - 0.5 ) ) ) ,$$
$$and Fr = \frac{\vert {U}_{mix} \vert}{\sqrt{gD cos ( θ ) ( \frac{{ρ}_{l} - {ρ}_{g}}{{ρ}_{l}} )}}$$
and where Li is a distance from the i'th finite control volume of the slug-tail domain to the slug-tail top, g is gravity, Uₘᵢₓ is total volumetric flow rate divided by the pipe's cross-sectional area, θ is pipe angle measured relative to the horizontal plane, ρ_{g} is gas density, and ρₗ, is volumetric mean of the densities of one or more liquids being in the finite control volume.

3. The computer implemented method according to claim 1, wherein the predetermined Taylor bubble velocity is determined by either empirical measurements of Taylor bubble velocities, or by predicting the predetermined Taylor bubble velocity by direct Navier-Stokes simulations.

4. The computer implemented method according to claim 1, wherein the predetermined Taylor bubble velocity is adjusted by the relation:
$${U}_{b} = {U}_{b , ∞} ( 1 + 0.56 {e}^{- 0.46 \frac{{L}_{S}}{D}} )$$
where U_{b,∞} is the velocity of a Taylor bubble that is pushing a long slug not affected by the wake effect, and L_{S} is the length of the slug in front of the Taylor bubble.

5. The computer implemented method according to claim 1, wherein the 1D CFD model applies a slug-capturing approach where the 1D multiphase flow equations are solved on a grid with Δx≤10·D, where Δx is a cell length of a finite control volume of the section of interest.

6. A method for optimising the design of a pipeline-based fluid transportation system for transporting a multiphase fluid flow, wherein the method comprises:
preparing at least two different designs of the fluid transportation system,
applying the computer implemented method according to claim 1 to predict the fluid behaviour in each of the at least two different designs, and
applying the predicted fluid behaviour to determine the optimised design of the fluid transportation system.

7. The method according to claim 6, wherein the optimisation of the design of the pipeline-based fluid transportation system assesses the effect on the fluid behaviour of varying one or more factors chosen from; pipeline diameter, pipeline trajectory in the terrain, number of pumps for pressure support, their location and pressure enhancing effect, and number of choking valves, their location and flow volume reducing effect with the aim to save capital investment and operational costs by identifying the optimum physical dimensions and/or trajectory in the terrain of the transport systems pipes without compromising on fluid behaviour stability and throughput.

8. The method according to claim 6, wherein the optimisation of the design of the pipeline-based fluid transportation system applies the simulated slug sizes and frequency of slugs to optimize the size of the receiving facilities such as a slug catcher and/or a slug separator.

9. The method according to claim 6, wherein the optimisation of the design of the pipeline-based fluid transportation system applies the simulated slug sizes and frequency of slugs to assess forces exerted on pipe bends and free-span piping in the pipeline-based fluid transportation system.

10. A method for trouble-shooting flow problems during operation of a pipeline-based fluid transportation system for transporting a multiphase fluid flow, wherein the method comprises:
applying the computer implemented method according to claim 1 loaded with a computational domain representative for the transport system having flow problems and with flow characteristic input data of the flow in the transportation system to predict the effect on the fluid behaviour in the transport system from possible mitigation actions, and
applying the predicted fluid behaviours to determine which mitigation action which is to be physically implemented on the transport system having flow problems.

11. The method according to claim 10, wherein the trouble-shooting flow problems during operation of a pipeline-based fluid transportation system comprises predicting the effect on the fluid behaviour in the transport system from mitigating actions such as regulating the flow volumes in the transport system, topside choking and/or gas lift.

12. A computer program, comprising processing instructions which causes a computer to perform the method according to claim 1 when the instructions are executed by a processing device in the computer.

13. A computer, comprising a processing device and a computer memory, the computer memory is storing a computer program as set forth in claim 12.

14. An autonomous flow management system comprising:
a flow simulation unit,
a sensor configuration comprising at least a first sensor located at an upstream end and a second sensor located at an downstream end of the pipeline-based transport system and measuring one or more characteristic flow parameter(s) of the multiphase fluid flowing through the pipeline-based transport system,
an actuator configuration comprising at least one actuator adapted to regulate the flow of fluid through the pipeline-based transport system, and
a control unit adapted to:
receive signals from the sensor configuration measuring one or more characteristic flow parameter(s) and transferring the signals to one or more boundary conditions passed on to the flow simulation unit, and
receive simulation results from the flow simulation unit and transferring the simulation results to set point values passed on to the actuator(s) of the actuator configuration,
wherein
the flow simulation unit comprises a computer loaded with a software, which when executed performs a computer-implemented method simulating the fluid behaviour of the multiphase flow flowing in the pipeline-based transport system with the boundary condition(s) from the control unit,
characterised in that
the software of the computer of the flow simulation unit is the computer program according to claim 12.

15. The autonomous flow management system according to claim 14, wherein the flow management system further comprises a second actuator located at the downstream end of the pipeline-based transport system and/or a third actuator located anywhere in-between the upstream and downstream end of the pipeline-based transport system.

16. The autonomous flow management system according to claim 14, wherein the control unit (20) is a Distributed Control System, a Programmable Logic Controller, an Edge Gateway, a SCADA system or a Historian System or Timeseries Database being implemented to covering automation layers 0, 1, and 2 according the standard: ANSI/ISA-95.00.01-2010 (IEC 62264-1 Mod) Enterprise-Control System Integration—Part 1: Models and Terminology.

17. The autonomous flow management system according to claim 14, wherein the first sensor of the sensor configuration of the flow management system comprises a temperature sensor located at the upstream end of the pipeline-based transport system, and:
either:
the first sensor further comprises a pressure sensor and the second sensor comprises a pressure sensor,
the first sensor further comprises a pressure sensor and the second sensor comprises a flow sensor,
the first sensor further comprises a flow sensor and the second sensor comprises a pressure sensor,
or
the first sensor further comprises a flow sensor and the second sensor comprises a flow sensor.

18. The autonomous flow management system according to claim 14, wherein the control unit determines the set point values may by using one or several of the following algorithms: PID control loop, Pre-trained machine learning algorithm, and/or Global or local optimum search algorithm.

19. The autonomous flow management system according to claim 14, wherein the actuator of the actuator configuration is either a control valve, a drum separator, a compressor, a gas injector, or a pump.
